(19) United States
(12) Patent Application Publication
(10) Pub. No.: US 2004/0060851 A1
(43) Pub. Date: Apr. 1, 2004

(54) Water saving cabinet type gravity filter and water storage

(76) Inventor: Zoltan Egeresi, Santa Cruz, CA (US)

Correspondence Address: ZOLTAN EGERESI, 5500 COAST RD., SANTA CRUZ, CA, 95060, US

(21) Appl. No.: 10/392,235

(22) Filed: Mar. 20, 2003

Related U.S. Application Data
(60) Provisional application No. 60/416,594, filed on Sep. 30, 2002.

(51) Int. Cl. B01D 36/00

(52) U.S. Cl. 210/149; 210/172; 210/418

(57) ABSTRACT

This water saving gravity filter/storage tank has three functions:

Water saver, water from hot water line is diverted to an over head storage tank until the hot water from the water heater reaches the faucet and warms up the pipe water saving can become substantial.

Gravity water filter, water stored in the tank flows back to the sink through a filter below using gravity flow. Using the stored water constantly keeps the water recycled, fresh.

Most type of commercially available filter can be used.

Water storage, 5-10 gallon water container in the cabinet will give extra emergency water storage, which is specially important in locations where water pressure, cost of water, quantity of available water supply may not be always stable or home is located where the area is prone to natural disaster like earth quake.

This water saving gravity filter/storage invention saves water as in more and more places in the World water becomes a scarce and costly commodity or drought induced water shortage creates limitations.

### BACKGROUND OF THE INVENTION

As population increases, so does the requirement for more and more treated drinking water. Treated drinking water is in short supply in many arid areas and even in places where there is plenty fresh water, chlorinating filtering pumping does cost a lot of money.

This water saving gravity filter/storage invention saves water as in more and more places in the World water becomes a scarce commodity. Only a few percentage of homes have a hot water re-circulating system where no cold water is wasted while waiting for the hot water at the sink. This type of re-circulating system is a costly installation, depending the size of the home and water heater location.

This water saving gravity filter/storage is installable in any home or in apartments.

This invention can use almost any kind of water filter currently on the market, saves water and also functions as a re-circulating water storage.

### BRIEF SUMMERY OF THE INVENTION

This water saving gravity filter/storage tank has three functions, the most important is the drinking water recovery which is not part of any prior art.

Water saver, water from hot water line is diverted to an over head storage tank till the hot water from the water heater reaches the faucet and warms up the pipe. Depending on pipe length, size of family frequency of water usage, water saving can become substantial.

Gravity water filter, water stored in the tank flows back to the sink through a filter below using gravity flow. Return on/off valve is attached to the diverter giving the option to use stored cold water or mix it with hot water. Using the stored water constantly recycling will keep it fresh.

Most type of commercially available filter can be used.

Water storage, 5-10 gallon water container in the cabinet will give extra emergency water storage, which is specially important in locations where water pressure, cost of water, quantity of available water supply may not be always stable or home is located where the area is prone to natural disaster like earth quake.

### PRIOR ART

There are many type of water filters on the market, most of them are connected directly to the faucet, or installed under the sink, all are pressure driven. Different type of filters shapes and types are available filtering out sediments, impurities, chemical elements and so on. All known prior art designed drinking water filter systems are pressure driven, in line water system.

This Water saving cabinet type gravity filter and water storage is a new and different design, as the primary function is water saving than filtering than storing the water for emergency.

| | |
|---|---|
| Current U.S. Class: | 137/544; 137/625.46; 210/424 |
| Interni Class: | B01D 035/04; F16K 011/074 |
| Field of Search: | 137/544,625.46 210/424 |

### U.S. Patent Documents Relating to Water Filters

U.S. Patent Documents relating to water filters

| | | | |
|---|---|---|---|
| 4329162 | May 1982 | Pitcher, Jr. | 55/523. |
| 4340403 | July 1982 | Higuchi et al. | 55/523. |
| 4781831 | November 1988 | Goldsmith | 210/247. |
| 4894160 | January 1990 | Abe et al. | 210/510. |
| 4969996 | November 1990 | Hankammer | 210/282. |
| 5009781 | April 1991 | Goldsmith | 210/247. |
| 5114581 | May 1992 | Goldsmith | 210/650. |
| 5451444 | September 1995 | DeLiso et al. | 428/116. |
| 5597617 | January 1997 | DeLiso et al. | 427/228. |
| 5750026 | May 1998 | Gadkaree et al. | 210/502. |
| 4329162 | May 1982 | Pitcher, Jr. | 55/523. |
| 4428758 | January 1984 | Montierth | 55/523. |
| 4540489 | September 1985 | Barnard | 210/287. |

| | | | |
|---|---|---|---|
| 5728287 | March 1998 | Hough et al. | 205/743. |
| 5759384 | June 1998 | Silveri | 205/743. |
| 5876575 | March 1999 | Kump | 204/197. |
| 5911870 | June 1999 | Hough | 205/701. |
| 5928503 | July 1999 | Shang-Chun | 210/86. |
| 5944978 | August 1999 | Okazaki | 205/701. |
| 3863675 | February 1975 | Wiltshire | 137/625. |
| 4115276 | September 1978 | Kelly | 210/425. |
| 5452744 | September 1995 | Otto | 137/625. |
| 3519134 | July 1970 | Hassinger, | |
| D253066 | October 1979 | Karamian. | |
| 4287057 | September 1981 | Stanley., | |
| 4504389 | March 1985 | Rundzaitis. | |
| D328942 | August 1992 | Igami et al., | |
| D358868 | May 1995 | Hembree et al. | |
| D398369 | September 1998 | Hayes et al. | D23/209. |
| 5833849 | November 1998 | Primdahl | 210/460. |
| D410728 | June 1999 | Kurth et al. | D23/209. |
| 5993648 | November 1999 | Hunter et al. | 210/460. |
| D438592 | March 2001 | | |

### Foreign Patent Documents

0322167 September 1989 EP., 0795703 September 1997 EP., 60109676 June 1985 JP.

2150168 March 1973 FR. 105641 May 1917 GB.

2 197 647 March 1990 GB. 63-12392 January 1988 JP 210/266.

4-108589 April 1992 JP 210/188., 4-156993 May 1992 JP 210/266.

2 233 002 October 1973 DE.

0 236 071 September 1987 EP.

WO 84/04050 October 1984 WO.

### DETAILED DESCRIPTION OF THE INVENTION

This water saving gravity filter/storage tank has three functions, the most important is the drinking water recovery which is not part of any prior art.

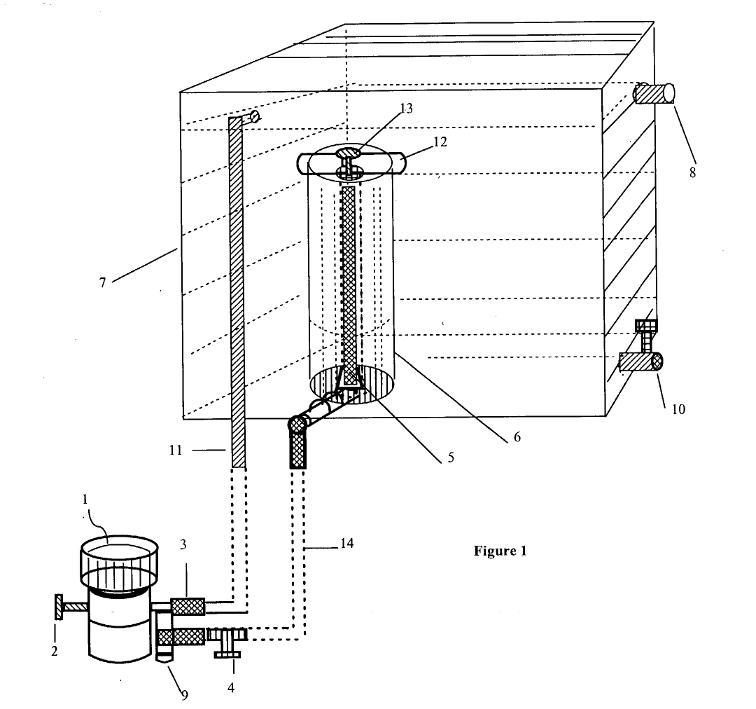

FIG. 1. Water storage tank (7) located above the kitchen sink in the cabinet or above any sink where it may be suitable. Water flowing from the water heater in the hot water line is cold until the cold water is flashed out and the hot water warms up the pipe. Diverter (1) connects to the faucet, when activated by lever (2) and allows cold water to flow up to the storage tank (7) through connector (3) and flexible pipe or hose (11). When water warms up, diverter lever (2) can be released for regular hot water use.

When storage tank is full, overflow pipe (8) will carry the water to an external tank, usually an outside tank. Valve (10) is a drain valve. When cold or drinking water is needed, valve (4) needs to be opened, it will let the water from cabinet storage tank (7) by gravity flow through water filter (6).

In the center of the water filter (6) water is filtered water pipe (5) which drains the storage tank.

Water filter (6) is slightly elevated from the bottom to have room for the drain pipe (14) and is held in a fixed position by bracket (12) with plastic screw (13).

### SUMMERY OF THE INVENTION

This Water saving gravity filter/storage tank has three functions, the most important is the drinking water recovery which is not part of any prior art, gravity filter and emergency water storage.

In respect, after explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. It is important, therefore, that the claims be regarded as including such equivalent constructions insofar as they do not depart from the spirit and scope of the present invention, or is it intended to be limiting as to the scope of the invention in any way.

1. What I claim as a new utility invention is the Water saving gravity filter/storage tank, which has three functions (one claim) and I am asking for a Patent protection.
Water saver, water from hot water line is diverted to an over head storage tank till the hot water from the water heater reaches the faucet-and warms up the pipe. Depending on pipe length, size of family frequency of water usage, water saving can become substantial.
Gravity water filter, water stored in the tank flows back to the sink through a filter using gravity flow. Return on/off valve is attached to the diverter giving the option to use stored cold water or mix it with hot water. By constantly using the stored water, recycling will keep it fresh while saving natural resource. This design allows the use of most commercially available filter, this invention lets you select the best type water filter which is the most suitable for the local water conditions and filtering requirement.
Water storage, 5-10 gallon water container in the cabinet will give extra emergency water storage, which is specially important in locations where water pressure, cost of water, quantity of available water supply may not be always stable or home is located where the area is prone to natural disaster like earth quake. Millions of gallons of treated drinking water is wasted on a daily bases while we all wait for the hot water at the sink. As the population increases so does the need for this important resource. This invention has a potential to save millions of gallons of water for end users and for utility companies.
In respect, before explaining at least one embodiment of the invention in detail, it is to be understood that the invention is not limited in its application to the details of construction and to the arrangements of the components set forth in the following description or as it is illustrated in the drawings.
